(19) United States
(12) Patent Application Publication
(10) Pub. No.: US 2002/0174150 A1
(43) Pub. Date: Nov. 21, 2002

(54) Systems and methods for dynamic national language service

(75) Inventors: Chi-Thanh Dang, Tucson, AZ (US); Rambabu Achanta, Torrance, CA (US); Robert J. Hatton, Huntington Beach, CA (US); Kiranmayee Potnuru, Torrance, CA (US); Patricia Agbulos, Saugus, CA (US)

Correspondence Address: OLIFF & BERRIDGE, PLC, P.O. BOX 19928, ALEXANDRIA, VA, 22320, US

(73) Assignee: Xerox Corporation, Stamford, CT (US)

(21) Appl. No.: 09/859,425

(22) Filed: May 18, 2001

(51) Int. Cl. G06F 15/00

(52) U.S. Cl. 707/536

(57) ABSTRACT

Dynamic language translation is provided for a content portion through the use of a dynamic translation service which stores language information associated with specific client and user information. The dynamic translation service determines a language based on the client and user information. A skeleton of the content portion is then determined containing content elements of the content portion. The skeleton content elements are translated into the determined language based on the client and user information using stored translation tables of each skeleton content element or using dynamic natural language translation of each skeleton content element. The translated skeleton content elements are then merged into the content portion.

### BACKGROUND OF THE INVENTION

1. Field of Invention

This invention relates to the managing of national language information.

2. Description of Related Art

The rapid expansion of the Internet and networking technologies has considerably reduced communications costs. However, this reduced cost has come at the expense of increased complexity in the design and maintenance of networked computer systems and networked applications. These costs have increased the total cost of ownership for many of these networked applications.

In response, many application service providers have attempted to reduce costs by maintaining the networked computer systems and applications necessary to support business functions, such as payment processing, invoicing, digital rights management, and content delivery, such as streaming audio and video. The application service provider develops expertise in providing access to the particular business functions and delivers access over a communication network such as the Internet.

For example, a referring web site requiring credit card authorization or debit card processing services may out-source that function to a payment processor application service provider. The payment processor maintains the service connections to the bank networks, clearing houses, American Express® and Visa®. The payment processor may use a secure protocol, such as https or the like. When a user of the web site selects the web site payment page, the request is referred to a secured web server, maintained by the payment processor for entry of the credit card information. In this way, the user's sensitive credit card information is not stored on the referring web site, security is increased and costs are lowered.

However, when the user of the web site is referred to the out-sourced page, the language of the referring site may be different than the language of the content provider.

In response some application service providers, digital libraries and web sites have attempted to incorporate consistent pictograms into their sites to provide an indication of the functions associated with each labeled item without reference to a user's language. One example of a pictogram is the pictogram of several coins and notes used to indicate a money exchange site at an airport. Though, pictograms are useful in conveying simple information, the usefulness of a pictograms decreases as the complexity of the information to be conveyed increases.

Other application service providers have attempted to address these national language service problems by translating a copy of each web page into each of the target languages. However, this has the disadvantage of increasing the storage requirements necessary for storing essentially the same content information. Also, additional languages are difficult to add to the system. Maintenance costs are increased as each additional web page multiplies the number of links which must be maintained and therefore also multiplies the number of possible errors.

Still other application service providers attempt to address these integration problems by requiring the user to design the page or content portion to be viewed. These application service providers merely provide information which the referring web site uses to build an appropriate page. The web site designer is therefore responsible for providing the appropriate national language translation. This has the disadvantage of not fully exploiting the application service provider's expertise. For example, a payment processor may have already identified the proper translation or phrase to prompt the user to enter the correct field information. An individual web site may not be aware that an end-user is entering village information into a city field until a shipping problem occurs.

### SUMMARY OF THE INVENTION

Thus, systems and methods for dynamic national language service comprising dynamic translation of content elements based on a client and or user would be useful.

The systems and methods for dynamic national language service according to this invention dynamically translate a skeleton or virtual content portion or virtual extensible markup record such as that described in co-pending U.S. application entitled “Systems and Methods for Managing Identity Information”, filed May 18, 2001, Attorney Docket No. 109445, assigned to Xerox Corporation and incorporated herein by reference in its entirety.

The systems and methods for dynamic national language service according to this invention dynamically translate a skeleton or virtual content portion comprising content elements based on language information that is associated with each client and/or user. For example, when a client associated with the French language requests content from a content provider, the request is mediated by the systems and methods for dynamic national language service according to this invention. The dynamic national language service according to this invention determines translations of each content element making up a skeleton or virtual content record associated with the requested web page. Each of the content elements in the skeleton or virtual content portion is then translated into French. The translation may take place dynamically using a natural language parsing system or the systems and methods of the dynamic national language service may use tables containing relevant translations of each content element into the French language.

Thus, for example, the content elements making up a navigation bar of a web page or the content elements making up a purchase page can be quickly and easily translated into a language specific to the requesting client or user. In various alternative embodiments according to this invention, the content elements may be translated dynamically using a natural language translation facility without requiring prior translation of the language table information into the desired language.

In various other embodiments according to this invention, graphic language content elements may be generated for content elements associated with pictographic languages such as Japanese, Chinese and/or Korean. These graphic language content elements may be generated dynamically or may be stored in the language tables. The skeleton or virtual content record may incorporate these graphic language content elements into Internet graphic format “png” files or any other supported graphic file format which can then be incorporated into the skeleton or virtual content portion. A stylesheet may then be applied to the content elements and the resulting merged content portion returned to the client allowing the client to read translations of each requested web page without the need to load a specific character set.

It will be apparent that the systems and methods for dynamic national language service according to this invention may be used to translate content elements between national languages or may be used to translate a national language text into speech using a speech synthesizer, into tactile media such as braille to translate between text and voice, printed material or any type of known or later developed medium without departing from the spirit or scope of this invention.

These and other features and advantages of the dynamic national language service are described in or are apparent from the following detailed description of the systems and methods according to this invention.

### BRIEF DESCRIPTION OF THE DRAWINGS

Various exemplary embodiments of this invention will be described in detail, with reference to the following figures, wherein:

FIG. 1 shows an exemplary embodiment of a system for dynamic national language service according to this invention;

FIG. 2 shows a flowchart outlining an exemplary embodiment of a method for dynamic national language service according to this invention;

FIG. 3 shows in greater detail a flowchart outlining an exemplary embodiment of a method for dynamic national language service according to this invention;

FIG. 4 shows in greater detail a first exemplary embodiment of the system for dynamic national language service of FIG. 1 according to this invention;

FIG. 5 shows in greater detail a second exemplary embodiment of the dynamic national language service of FIG. 1 according to this invention;

FIG. 6 shows an exemplary data structure for content element storage according to this invention;

FIG. 7 shows an exemplary data structure for storing language information according to this invention;

FIG. 8 shows an exemplary data structure for storing textual and graphic translations of content elements according to this invention;

FIG. 9 shows a second exemplary data structure for storing translations of textual and graphical content elements according to this invention.

### DETAILED DESCRIPTION OF EXEMPLARY EMBODIMENTS

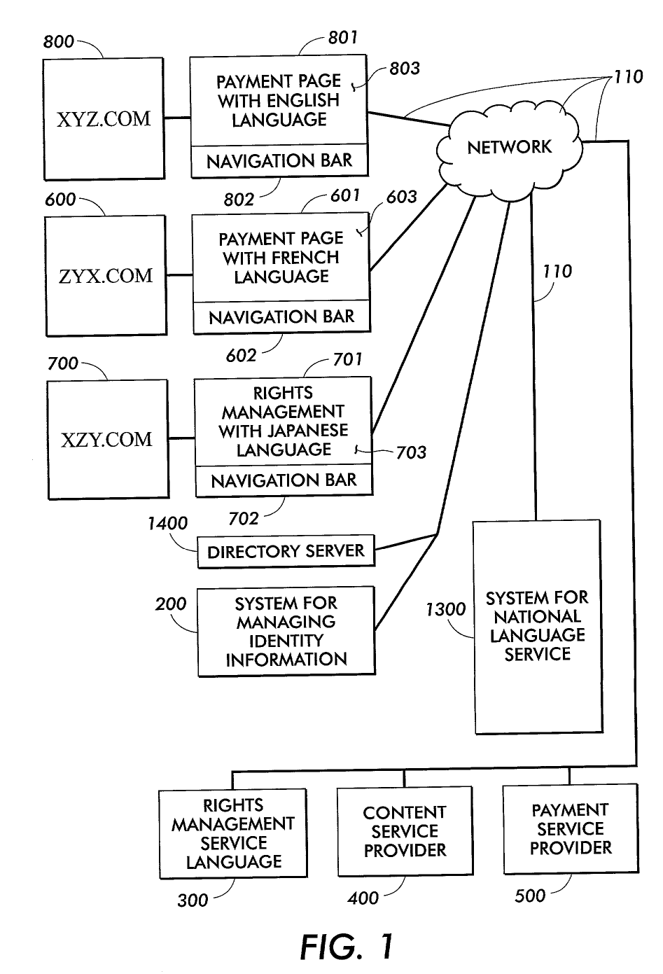

FIG. 1 is an exemplary embodiment of a system for managing national language service 1300 connected over communication links 110 to one or more application service providers 300-500 and to one or more client web sites 600, 700 and 800. Each client web site 600, 700 and 800 contains out-sourced pages 601, 701 and 801 respectively. Each of the client web site pages 601, 701 and 801 are composed of content elements such as navigation bars 602, 702 and 802. The navigation bars 602, 702, 802 and the other content elements on the respective web pages form a skeleton or virtual content portion. The skeleton or virtual content portion for each out-sourced web site page 601, 701 and 801 might appear in different languages. For example, the content elements 603 of out-sourced payment page 601 have been translated into the French language. Similarly, the content elements 703 of out-sourced digital rights management page 701 have been translated into the Japanese language and the content elements 803 of out-sourced payment page 801 have been translated into English using the system for national language service 1300.

The system for national language service 1300 provides for flexible and easily expandable translation of content from one or more content providers 300500 without requiring the referring web sites 600-800 to serve multiple pages.

For example, requests for a payment content portion or web page from the XYZ referring client web site 800 are mediated by the system for national language service 1300. The system for national language service 1300 requests content information from the payment service provider 500 relating to the payment transaction. The content provider information from the payment service provider 500 is integrated into the skeleton or virtual content record. The system for national language service 1300 then translates the content elements making up the skeleton or virtual content record based on the information from the XYZ referring client web site 800. Since the XYZ referring client web site is associated with the English language, the content elements such as the navigation bar 802 are each translated into English. It will be apparent that the translation may use dynamic translation such as natural language parsing, previously encoded translation tables or any other known or later developed method of providing the translation without departing from the spirit or scope of this invention.

The system for national language service 1300 allows information services to be made quickly available in multiple languages while preserving the look and feel of the referring client web site. Integration of the content information and the XYZ referring client web site 800 is thus maintained. The end-user experience of the look and feel of the XYZ referring client web site 800 is maintained while also facilitating access in other languages. Since the look and feel are maintained across language versions, the end user is able to find information more quickly and effectively. The identity, look and feel and/or branding associated with the XYZ referring client web site 800 is reinforced by consistent presentation of the XYZ referring client web site while also facilitating access across multiple languages. The language information also includes the specification of alternate fonts or translation or transformations to alternate graphic versions of alternate fonts to be used in content elements when specific national language fonts are unavailable to a user.

The payment page 801 of the XYZ referring client web site 800 is provided with a national language translation into the English language by the system for national language service 1300. The system for national language service 1300 uses referring client identifying information, such as the client internet protocol address information contained in an hypertext transfer protocol request to determine a client identifier. In various exemplary embodiments of system for national language service 1300, the client identifier is used as an index into a client national language storage. However it will be apparent that any known or later-developed technique for associating a client with corresponding national language information may be used in the practice of this invention.

The client national language storage stores language information for each client and/or user of each client web site. For example, the client national language storage may store information indicating that XZY referring client would like all pages served in Japanese. Alternate rules may be specified, such as for example, if the user is associated with a specific group of Internet protocol addresses, an alternate language such as French should be used. In various alternative embodiments according to this invention, a client's certificate, internet protocol address, domain service information, session identifier, preferred language setting in a directory server or any other known or later developed method of associating the client may be used to determine a preferred language according to this invention.

Similarly, a second referring web site 600 for ZYX Corporation shows a French translation of each of the content elements 603 of web page 601. The payment merged content portion 601 merges the content elements, such as the French translation of the contents elements in the navigation bar 602 with the payment service provider 500 content information.

The XZY referring client web site 700 makes use of a rights management application provided by the rights management service provider 300. When a user attempts to access the rights management web page 701 of the XZY referring client web site 700, the request is forwarded over one or more of the communication links 110 to the system for national language service 1300. The system for national language service 1300 uses client identifying information, such as the referrer entry of the referring web site 700 in a hypertext transfer protocol request header, a cookie file or any other known or later-developed method, to determine the client information.

The client or user information is then used to determine the relevant language into which the skeletal or virtual content elements for the XZY referring client web site 700 is to be translated. For example, an entry in the directory server 1400 may indicate the client is located in Japan. A rule may associate all Japanese sites with Japanese as the determined language for XZY referring client web site 700. The content elements making up navigation bar 702 are determined and translated into the Japanese language. In this way, information stored in the XZY referring client web site 700 is consistently presented to users in different languages. In various alternative embodiments according to this invention, the system for managing identity information 200 may be used in which case the content element information may be retrieved from the associated identity storage.

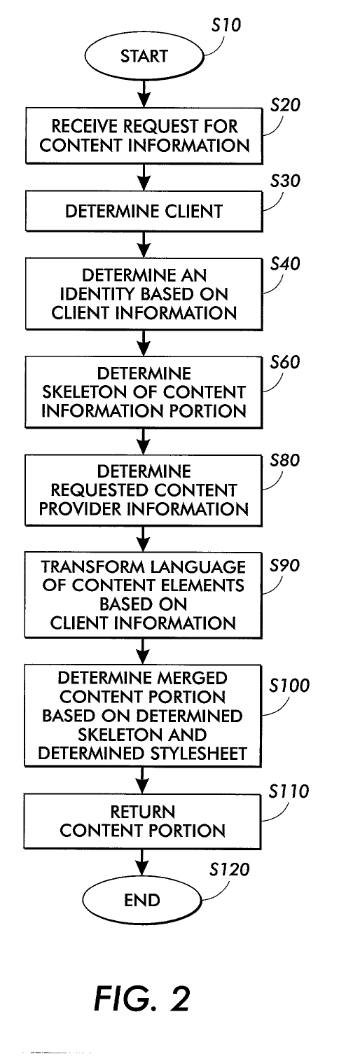

FIG. 2 shows an exemplary method for managing identity information. The process starts at step S10 and immediately continues to step S20. In step S20, a request for content information from a client is received. The request may be in the form of a hypertext transfer protocol request, a wireless access protocol request or any other known or later developed method of requesting content information. Control is then transferred to step S30 where the client is determined.

The client may be determined by examining the http referrer entry in the http request, by examining session identifier information, by examining DNS information associated with the referrer internet protocol entry information, using a directory server or any other known or later developed method of determining a client. Control continues to step S40.

In step S40, the identity associated with the client information is determined. In an exemplary embodiment according to this invention, an identity is determined based on the client information and can be inferred or determined from the client content information request. However, it will be apparent that any method of associating identity information with a client request may be used such as a session identifier, internet protocol address information lookup or any other known or later developed technique of associating a client request with the information in the client identity storage. Control then continues to step S60.

In step S60, a skeleton or virtual content portion is determined from the content portion. The skeleton or virtual content portion reflects the content elements determined to be associated with the content portion or web page. For example, the skeleton or virtual content portion can be a virtual xml record in which the virtual record content elements are based on a determined client. Control then transfers to step S80.

In step S80, the content provider information is retrieved. The content provider information may include, but is not limited to, information from databases or services such as payment processing, rights management, invoicing, content provisioning, human resources processing or any other service or information. Control then continues to step S90.

In step S90 the language of the content elements is transformed based on the determined client information. For example, if the client information indicates that French should be used, the content elements are identified and a translation from the first or source language to the French target language occurs. The determination of the first or source language may use any known or later developed method of language identification or the source language may be specified directly.

In step S100, the merged content portion is determined based on the skeleton or virtual content portion containing the translated content elements associated with the client and the content provider information. The resulting merged content portion includes the translations of the content elements into the associated national language based on the referring client web site. Control then continues to step S110 where the merged content portion is returned to the client and control continues to step S1120 where the process ends.

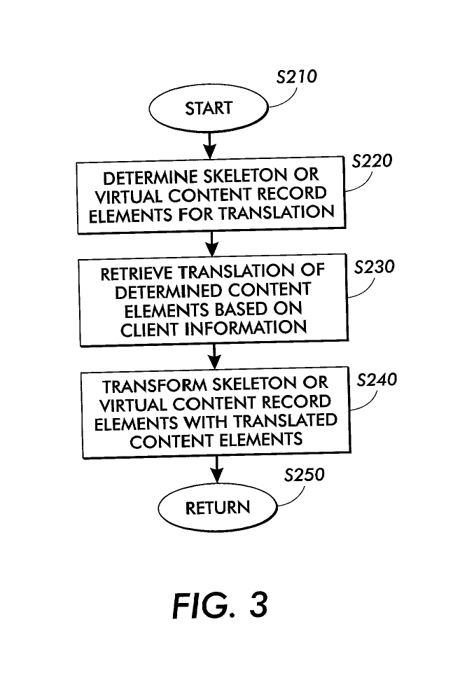

FIG. 3 shows in greater detail a flowchart outlining an exemplary embodiment of a method for dynamic translation according to this invention. The process is called from step S90 of FIG. 2 and starts at step S210. Control is immediately transferred to step S220.

In step S220 the skeleton or virtual content elements to be translated are determined and control continues to step S230. In step S230 each content element is translated based on the determined client information. Control then continues to step S240.

A transformation of the skeleton or virtual content record is performed in step S240. The transformation may include finding the source language content element and replacing it with the target language content element or any other known or later developed method of determining a translation of the content elements of the skeleton or virtual content record. Control then continues to step S250. In step S250 the process ends and control is returned to the calling step S90 of FIG. 2.

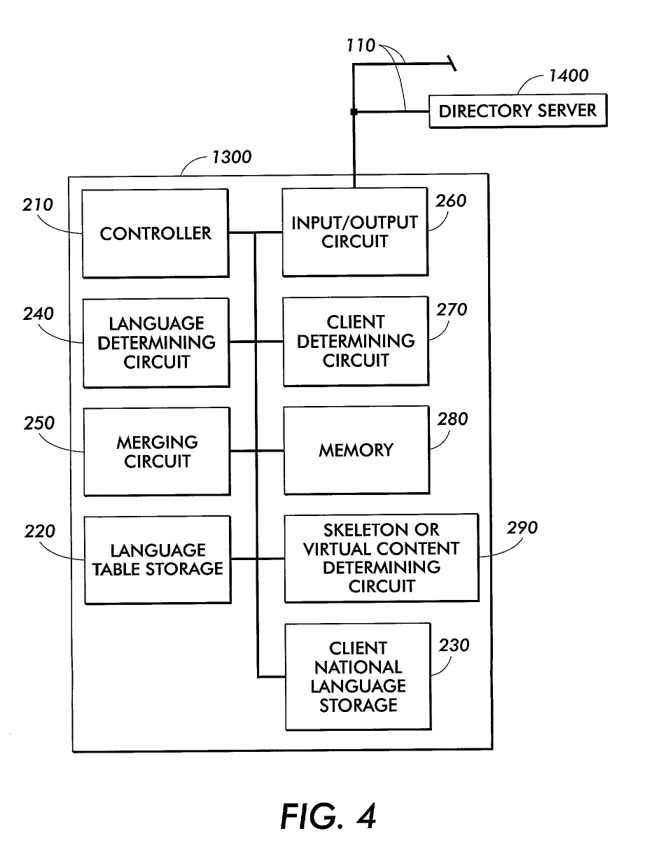

FIG. 4 shows in greater detail a first exemplary embodiment of the system for dynamic translation 1300 of FIG. 1 according to this invention. The system for national language service 1300 comprises a controller 210; a language table storage 220; client national language storage 230; a language determining circuit 240; a merging circuit 250; a client determining circuit 270; a memory 280; a skeleton or virtual content element determining circuit 290, an input/output circuit 260 connected over communication link 110 to optional directory server 1400.

The controller 210 activates the input/output circuit 260 to receive a request for a content portion. The client determining circuit 270 is activated to determine the client associated with the request. For example, the client may be determined from the referrer portion of an http header request. In various alternative embodiments according to this invention, a session identifier may be included in the http information passed by the referring client, an Internet protocol address lookup may be performed, a directory lookup service may be performed or any other known or later developed method of determining a client may be used.

The client information determined by the client determining circuit 270 is used by the language determining circuit 240 to determine the language based on the client information. The skeleton or virtual content record determined by the skeleton or virtual content determining circuit 290 is then translated into the language determined by the language determining circuit 240. The language is determined by analyzing the client national language storage to determine the rules to apply to the determined client information to determine the language. For example, the rules contained in the client national language storage may specify that if a user is identified as “handicapped-sight” then all translations should be made for a voice or tactile content element. The language translation may use the language storage table 220 which stores a translation of each content element in each supported language. Alternatively, a dynamic translation may be invoked such as a natural language parsing/translation system that translates each content element dynamically, or any other known or later developed translation technique may be used.

The skeleton or virtual content elements associated with the client, the content provider information are then merged by the merging circuit 250 to create a merged content portion in memory 280. The merged content portion saved in memory 280 is then transferred by the input/output circuit 260 over communication links 110 to the referring site (not shown). It will be apparent that translation of the content elements may occur before or after the merging of the content elements within the spirit and scope of this invention.

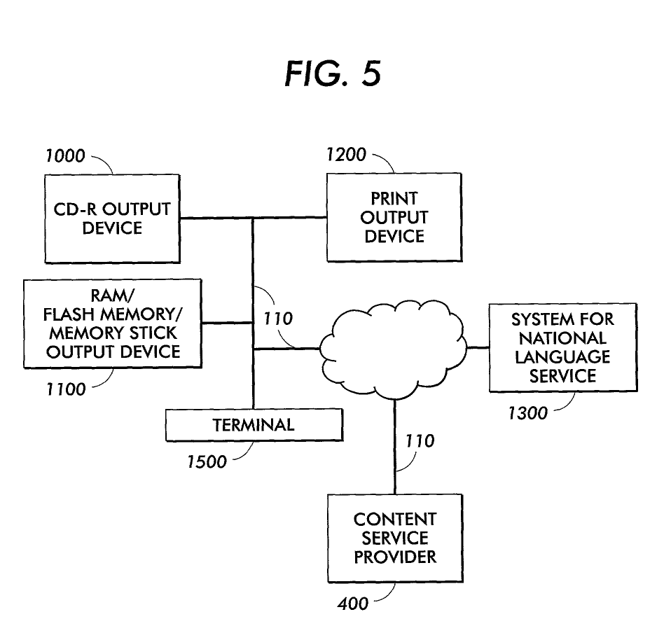

FIG. 5 shows a third embodiment of a system for system for national language service 1300 according to this invention. The system for system for national language service 1300 is connected over communications links 110 to content service provider 400; RAM/flash memory output device 1100; CD-R output device 1000; print output device 1200 and terminal 1400 over communications links 110.

A request for a digital, audio or a printed book is entered on terminal 1400 and forwarded to the system for system for national language service 1300. The referring client may be specified as any one or combination of the store or vendor in which the terminal is located; a target device code or identifier; a user identifier or a membership number. The client identifier may be entered directly to specify the identity to be applied to the content information from the content provider. The system for national language service 1300 constructs a merged content portion based on the translation information associated with the client information and the content provider 400. The merged content portion may be output to a RAM/flash memory output device 1100. In this way the translation may be applied to an entire electronic book and navigation controls suitable for the target device may be added in the appropriate language.

Similarly, the CD-R output device 1000 may be selected and the relevant translation applied to provide for reading a book on a computer or listening to an audio book in a CD music device.

The print output device 1200 may be selected and an appropriate identity specified using the client identifier from terminal 1400 to provide a specific language to be applied to the content portion provided by the content provider service 400. For example, the digital content of a book can be formatted with a client specific translation facility. The ability to generate such a dynamic translation makes works otherwise completely unavailable in the target language available for low cost in any language for which dynamic translation facilities are available. A book printed at a bookseller can be printed using virtually any language required.

The system for national language service 1300 provides a flexible and efficient system for managing translations with any type of content. For example, interactive audio books for the visually impaired, customized printed professional society books or e-books designed for reading on a personal digital assistant may be generated as merged content portions from the same content information provided by content service provider 400. Translations of merged content into different languages can be created based on the client requirements rather than the availability of a translation.

The translations may include content elements such as navigation elements, commands to navigate within the material or may include the consistent use of sounds or phrases as prompts to change media. In various alternative embodiments, a particular language may be associated with the audio book content or different voices and/or different languages may be applied to the audio book content depending on the speakers in the text and the client requirements. The merged content incorporating the translations may be transferred to RAM/ROM, Memory Stick® diskette or any other media capable of holding the information.

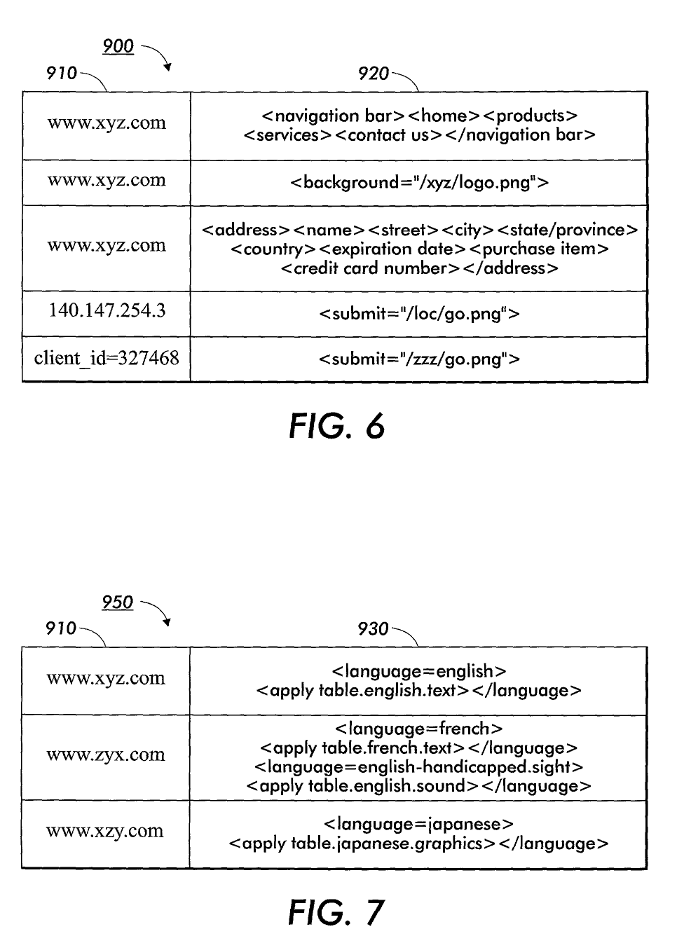

FIG. 6 shows an exemplary data structure for identity element storage 900. The exemplary data structure for identity element storage 900 comprises a client identifier portion 910 and a content element portion 920.

The client identifier portion 910 stores information that identifies the referring client to a system for managing style information 200. For example, in the first line of the exemplary data structure for identity element storage 900, the domain name “www.xyz.com” is used as the client identifier portion 910.

The content element portion 920 of the exemplary data structure for identity element storage 900 stores the content element information associated with each determined client. Thus, the navigation bar and associated content elements are indicated as being associated with client “www.xyz.com”.

Similarly, the second line of the exemplary data structure for identity element storage 900 indicates that the background image “logo.png” found in the xyz subdirectory specified in the content element portion 920 is associated with a “www.xyz.com” client identifier portion 910. The third line content element portion 920 indicates that elements: address, name, street, city, state/province, country, expiration date, purchase item and credit card number are all content elements associated with client identifier “www.xyz.com”.

The fourth line of the exemplary data structure for identity element storage 900 uses the internet protocol address “140.147.254.3” as the client identifier portion 910 and associates it with a submit button that uses the image “go.png” in the loc directory as indicated in the content element portion 920.

The fifth line of the exemplary data structure for identity element storage 900 uses a name/value string “client_id=327468” as the client identifier portion 910 and associates it with a submit button that uses the image “go.png” in the zzz directory as indicated in the content element portion 920.

It will be apparent that session information, cookie information, a unique identifier or any other known or later developed method of identifying a client may be used to determine the content elements associated with a given identity in the exemplary data structure for identity element storage 900.

FIG. 7 shows an exemplary data structure for client national language service storage 950. The exemplary data structure for client national language service storage 950 comprises a client identifier portion 910 and a language rule portion 930.

For example, the client identifier portion 910 of the first line indicates that the language rule portion 930 indicates that English translations using the English language table should be used as specified by the language rule portion 930 associated with client “www.xyz.com”.

The portion language rule portion 930 of line 2 associates the client having the domain name “www.zyx.com” with the French language. However, if the user is determined by a URL, cookie, directory lookup etc to have the name or attribute value of “english-handicapped.sight”, then the content elements will be translated to English sound.

Similarly, the language rule portion 930 of line 3 is associated with the domain name “www.xzy.com” as indicated in the client identifier portion 910. The Japanese graphics font translation table will be used to generate translations of the content elements to Japanese. It will be apparent that session information, cookie information, a unique identifier or any other known or later developed method of identifying a client may be used to determine the language rule associated with a given client in the exemplary data structure for national language service 950.

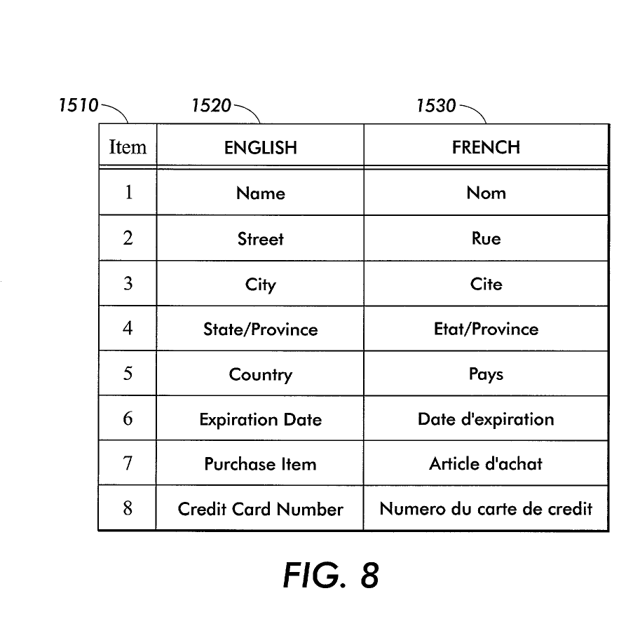

FIG. 8 shows an exemplary data structure for storing textual and graphic translations of content elements according to this invention. The content elements show the translations for content elements related to a credit card transaction such as Name, Street, City, State/Province, Country, Expiration Date, Purchase Item and Credit Card Number, each content element item is identified by item index number 1510. The English language portion 1520 includes the English language translation of each content element and the French language portion 1530 includes the corresponding French translation of the content element.

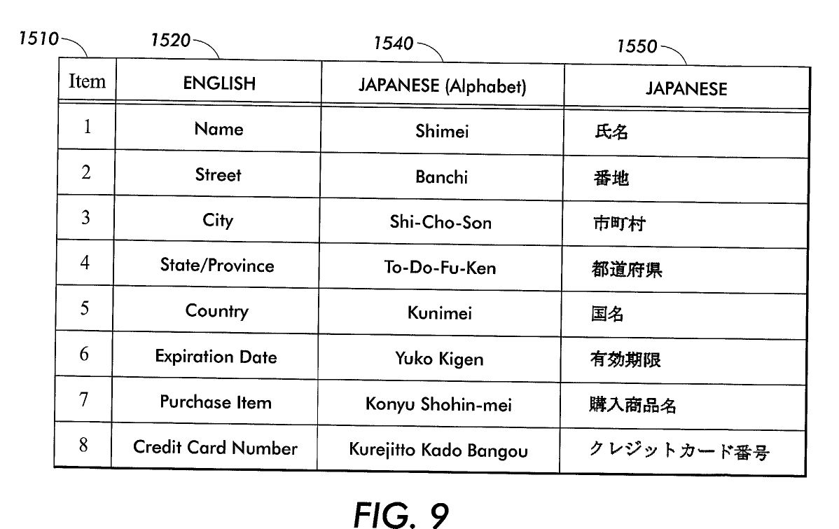

FIG. 9 shows a second exemplary data structure for storing translations of textual and graphical content elements according to this invention. Content element item portion 1510 identifies the content element. The English language portion 1520 is shown for comparison. The Japanese language content elements transliterated into Roman characters is encoded in the Japanese alphabet portion 1540 and a Japanese content element in graphic form is encoded in the Japanese graphic portion 1550. If a client specifies the site as requiring the Japanese language but the user browser does not support the Japanese character set, then the Japanese graphics content elements 1550 may be used to display the text as graphics on the client browser. However, if the user's browser supports Japanese characters then no graphics are required and the system transmits the relevant character codes directly.

In the various exemplary embodiments outlined above, the system for national language service 1300 can be implemented using a programmed general purpose computer. However, the system for national language service 1300 can also be implemented using a special purpose computer, a programmed microprocessor or microcontroller and peripheral integrated circuit elements, an ASIC or other integrated circuit, a digital signal processor, a hardwired electronic or logic circuit such as a discrete element circuit, a programmable logic device such as a PLD, PLA, FPGA or PAL, or the like. In general, any device, capable of implementing a finite state machine that is in turn capable of implementing the flowcharts shown in FIGS. 2-3 can be used to implement the system for the system for national language service 1300.

Each of the circuits 210-290 of the system for national language service 1300 outlined above can be implemented as portions of a suitably programmed general purpose computer. Alternatively, circuits 210-290 of the system for national language service 1300 outlined above can be implemented as physically distinct hardware circuits within an ASIC, or using a FPGA, a PDL, a PLA or a PAL, or using discrete logic elements or discrete circuit elements. The particular form each of the circuits 210-290 of the system for national language service 1300 outlined above will take is a design choice and will be obvious and predicable to those skilled in the art.

Moreover, the system for national language service 1300 and/or each of the various circuits discussed above can each be implemented as software routines, managers or objects executing on a programmed general purpose computer, a special purpose computer, a microprocessor or the like. In this case, the system for national language service 1300 and/or each of the various circuits discussed above can each be implemented as one or more routines embedded in the communications network, as a resource residing on a server, or the like. The system for national language service 1300 and the various circuits discussed above can also be implemented by physically incorporating the system for national language service 1300 into a software and/or hardware system, such as the hardware and software systems of a web server or a client device.

As shown in FIG. 4, memory 280, the language storage table 220 and the client national language storage 230 can be implemented using any appropriate combination of alterable, volatile or non-volatile memory or non-alterable, or fixed memory. The alterable memory, whether volatile or non-volatile, can be implemented using any one or more of static or dynamic RAM, a floppy disk and disk drive, a write-able or rewrite-able optical disk and disk drive, a hard drive, flash memory or the like. Similarly, the non-alterable or fixed memory can be implemented using any one or more of ROM, PROM, EPROM, EEPROM, an optical ROM disk, such as a CD-ROM or DVD-ROM disk, and disk drive or the like.

The communication links 110 shown in FIGS. 1 and 4-5 can each be any known or later developed device or system for connecting a communication device to the system for national language service 1300, including a direct cable connection, a connection over a wide area network or a local area network, a connection over an intranet, a connection over the Internet, or a connection over any other distributed processing network or system. In general, the communication links 110 can be any known or later developed connection system or structure usable to connect devices and facilitate communication

Further, it should be appreciated that the communication links 110 can be a wired or wireless links to a network. The network can be a local area network, a wide area network, an intranet, the Internet, or any other distributed processing and storage network.

While this invention has been described in conjunction with the exemplary embodiments outlines above, it is evident that many alternatives, modifications and variations will be apparent to those skilled in the art. Accordingly, the exemplary embodiments of the invention, as set forth above, are intended to be illustrative, not limiting. Various changes may be made without departing from the spirit and scope of the invention.

What is claimed is:

1. A system for managing dynamic translation comprising:
an client language storage for storing language information associated with a client and user;
a skeleton determining circuit for determining at least one skeleton content elements of a received content portion;
a language table storage for storing at least one translation of each of at least one skeleton content elements based on the skeleton content element and a language;
a client and user determining circuit for determining a client and user associated with a content portion;
a merging circuit for merging at least one translation of the at least one skeleton content elements based on the language associated with the determined client into the received content portion.

2. The system of claim 1, wherein the language table storage generates translated skeleton content elements using dynamic natural language translation.

3. The system of claim 1, wherein the client and user determining circuit determines at least one of a client identification and a user identification based on at least one of internet protocol address information, session identifier information, name pairs/value pairs and attribute/value pairs.

4. The system of claim 1, wherein the merged content portions are stored using at least one of an electronic medium; a printed medium and a paper medium.

5. The system of claim 1, wherein the merged content portions are at least one of an interactive electronic text, a printed text, an audio book and a video book.

6. A method for managing dynamic translation comprising:
receiving a content portion from a client;
determining at least one of a client and a user associated with the content portion;
determining at least one skeleton content elements of the received content portion;
determining at least one translated skeleton content elements from a language table based on the determined at least one client and user;
merging the at least one translated skeleton content elements into the content portion.

7. The method of claim 6, wherein the translated skeleton content elements are determined using at least one of dynamic natural language translation and language table look up.

8. The method of claim 6, wherein the client and user is determined based on at least one of internet protocol address information, session identifier information, name pairs and value pairs.

9. The method of claim 6, wherein determining the merged content portions produces at least one of an interactive text, a printed text, an audio book and a video book.

10. The method of claim 7, wherein the merged content portions are stored on at least one of electronic media, printed media and a paper media.

11. A computer readable storage medium comprising:
computer readable program code embodied on said computer readable storage medium, said computer readable program code usable to program a computer to perform a method for managing dynamic translation comprising the steps of:
receiving a content portion from a client;
determining at least one of a client and a user associated with the content portion;
determining at least one skeleton content elements of the received content portion;
determining at least one translated skeleton content elements from a language table based on the determined at least one client and user;
merging the at least one translated skeleton content elements into the content portion.

12. The computer readable storage medium comprising computer readable program code as in claim 11, wherein the translated skeleton content elements are determined using at least one of dynamic natural language translation and language table look up.

13. The computer readable storage medium comprising computer readable program code as in claim 11, wherein the client and user information is determined based on at least one of internet protocol address information, session identifier information and name and value pairs.

14. The computer readable storage medium comprising computer readable program code as in claim 11, wherein determining the merged content portions produces at least one of an interactive text, a printed text, an audio book and a video book.

15. The computer readable storage medium comprising computer readable program code as in claim 11, wherein the merged content portions are stored on at least one of electronic media, printed media and a paper media.

16. System for managing dynamic translation comprising:
an client language storage for storing language information associated with a client and user;
a skeleton determining circuit for determining at least one skeleton content elements of a received content portion;
a language table storage for storing at least one translation of each of at least one skeleton content elements based on the skeleton content element and a language;
a client and user determining circuit for determining a client and user associated with a content portion;
a merging circuit for merging at least one translation of the at least one skeleton content elements based on the language associated with the determined client into the received content portion.

17. The system of claim 16, wherein the language table storage generates translated skeleton content elements using dynamic natural language translation.

18. The system of claim 16, wherein the client and user determining circuit determines the client and user identifier based on at least one of internet protocol address information, session identifier information and name and value pairs.

19. The system of claim 16, wherein the merged content portions are stored on at least one of an electronic media; a printed media and a paper media.

20. The system of claim 16, wherein the merged content portions are at least one of an interactive electronic text, a printed text, an audio book and a video book.

21. A carrier wave encoded to transmit a control program usable for managing dynamic translation to a device for executing the control program, the device couplable to a language table storage that stores language information associated with a client and user, the control program comprising:
instructions for receiving a content portion from a client;
instructions for determining at least one of a client and a user associated with the content portion;
instructions for determining at least one skeleton content elements of the received content portion;
instructions for determining at least one translated skeleton content elements from a language table based on the determined at least one client and user;
instructions for merging the at least one translated skeleton content elements into the content portion.
